(19) United States
(12) Patent Application Publication
(10) Pub. No.: US 2005/0201521 A1
(43) Pub. Date: Sep. 15, 2005

(54) Diaphragm unit for an x-ray device

(75) Inventors: Burkhard Groh, Chicago, IL (US); Mathias Hornig, Erlangen (DE); Bernhard Sandkamp, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 11/076,744

(22) Filed: Mar. 9, 2005

(30) Foreign Application Priority Data
Mar. 11, 2004 (DE) 10 2004 012 050.1

(51) Int. Cl. G21K 1/02; G21K 1/04

(52) U.S. Cl. 378/147

(57) ABSTRACT

The invention relates to a diaphragm unit 4 or a diaphragm unit 4 and an associated x-ray emitter 1 with adjustment option for displaying an asymmetrical area under examination, with the diaphragm unit 4 being able to be tilted in accordance with the invention relative to the x-ray emitter 1, preferably by moving it on a rail system 12 attached isocentrically to the tube focus 9 on the tube housing 2 and/or the unit 1;4 made up of diaphragm unit 4 and x-ray emitter 1 being able to be tilted isocentrically to the tube focus 9 of the x-ray tube 2.

### CROSS REFERENCE TO RELATED APPLICATIONS

This application claims priority to the German application No. 10 2004 012 050.1, filed Mar. 11, 2004 which is incorporated by reference herein in its entirety.

### FIELD OF INVENTION

The invention relates to a diaphragm unit for an x-ray emitter and an x-ray device having a diaphragm unit, wherein an examination area can be at least partly exposed to the x-ray emitter.

### BACKGROUND OF INVENTION

X-ray systems are equipped with diaphragms which are used for variably restricting the x-rays to the required height and width. The undesired x-ray components are absorbed by the diaphragm blades which are normally made of lead. The diaphragms of such x-ray devices normally feature two pairs of lead blades. These pairs of blades are activated symmetrically to the center of the detector and isocentrically to the x-ray tube. The plate-type diaphragm blades cannot just be enlarged as required since this would also enlarge the aperture which for example leads to limitations in angulations on a C-arm of the x-ray device. An asymmetric display of an area under examination by means of a mechanical movement of the detector or the C-arm is known from DE 101 33 657 A1.

### SUMMARY OF INVENTION

It is therefore an object of the invention to adjust the area of the image that can be displayed, especially by expanding it asymmetrically in a simple manner.

This object is achieved by the claims.

The diaphragm unit in accordance with the invention or the diaphragm unit and the x-ray emitter in accordance with the invention or the inventive method for adjusting a diaphragm unit or a diaphragm unit and an x-ray emitter offer expanded options for adjusting the area able to be displayed. The user is therefore not exclusively confined to the conventional symmetrical settings. With the present invention different sized areas of the detector can be displayed in different forms as well as at different positions in a particularly simple way. This variability of the display areas is especially advantageous if patients are not to be examined in standard positions. A further advantage of the invention lies in the fact that existing diaphragms can continue to be used. Only the mechanical control and linkage for the inventive adjustment of diaphragm unit or diaphragm unit and x-ray emitter have to be expanded.

In accordance with the first embodiment of the invention the diaphragm unit and the x-ray emitter constitute one unit which can be tilted in its entirety such that the area under investigation can be displayed asymmetrically. This embodiment offers a particularly simple construction since only one mechanism for tilting the otherwise unchanged unit has to be provided but no modifications have to be made to the x-ray emitter and diaphragm unit. The unit is advantageously able to be tilted isocentrically to the tube focus. The retention of the x-ray tube focus brings the advantage that the scatter ray grid in front of the detector for reduction of scatter rays can continue to be used.

In a further embodiment of the invention there is provision for the diaphragm unit to be moveable in a circumferential direction of an x-ray housing accommodating the x-ray emitter relative to the former An especially simple construction here provides a system which advantageously moves isocentrically to the tube focus; This allows the diaphragm unit to be tilted relative to the x-ray emitter and the distance between diaphragm unit and tube focus to remain unchanged. Expediently the diaphragm unit is only moved far enough to remain in the exit opening of the X rays. With the inventive tilting of the diaphragm unit edge areas of the detector can also be displayed which is not achievable with the conventional design.

### BRIEF DESCRIPTION OF THE DRAWINGS

The invention as well as further advantageous embodiments in accordance with features of the subclaims are explained in more detail below with reference to schematic exemplary embodiments in the drawing; The Figures show:

FIG. 1 a conventional arrangement consisting of diaphragm unit and x-ray emitter viewed from the side,

FIG. 2 the arrangement in accordance with FIG. 1 viewed from below,

FIG. 3 an inventive exemplary embodiment in accordance with claim 2 viewed from the side,

FIG. 4 an inventive exemplary embodiment in accordance with claim 1 in a symmetrical starting position viewed end-on,

FIG. 5 the arrangement in accordance with FIG. 4 rotated by 90° viewed from below

FIG. 6 an inventive exemplary embodiment in accordance with claim 1 adjusted asymmetrically viewed end-on,

FIG. 7 the arrangement in accordance with FIG. 6 rotated by 90° viewed from below.

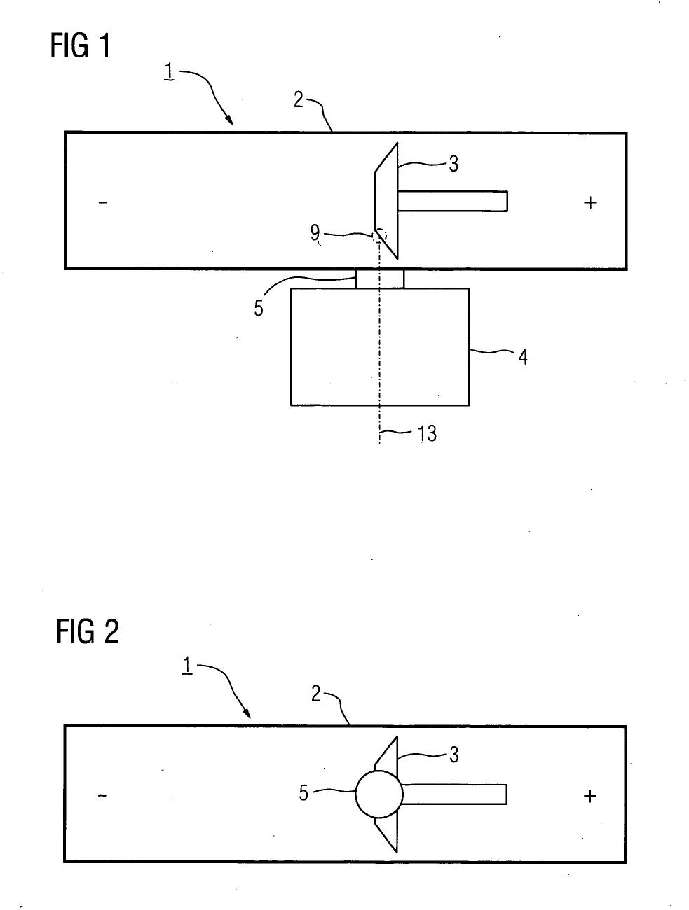

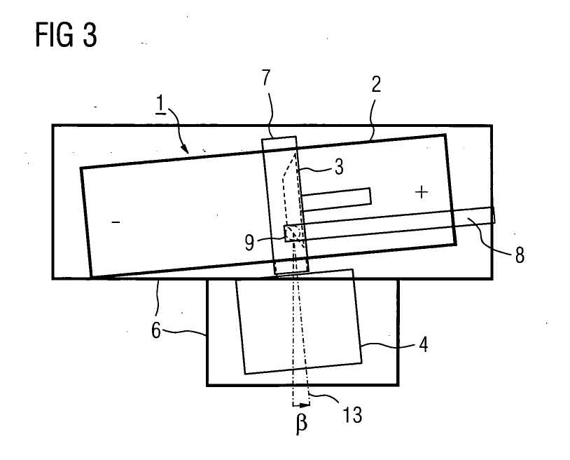

In accordance with FIG. 1 to FIG. 3, in an—emitter housing 6 only shown in FIG. 3 an x-ray emitter 1 with an anode 3 provided in a surrounding tube housing 2 and with a diaphragm unit 4 provided in the area of the exit opening 5 of the x-rays is arranged. FIG. 1 and FIG. 2 show—with the x-ray housing omitted to aid clarity—a conventional arrangement for displaying symmetrical areas under examination. To make the diagram clearer FIG. 1 shows the axis of symmetry 13. The anode 3 is usually a rotatable anode. From the tube focus 9 at the anode 3 as source, the emitted X rays leave the x-ray housing 2 in the direction of the axis of symmetry 13 through an exit opening 5 and enter the diaphragm unit 4.

The constructional unit 1;4 in accordance with the invention shown in FIG. 3, consisting of diaphragm unit 4 and x-ray emitter 1 is attached by means of a tube hanger 7 to a swivel arm 8. The swivel arm 8 is arranged so that a tilting of the entire unit 1;4 by means of the swivel arm 8 around the tube focus 9 of the x-ray tube is guaranteed. The unit 1;4 is tilted in FIG. 3 in comparison to FIG. 1 by an angle relative to the angle of symmetry 13. Tilting by means of the swivel arm 8 provides a particularly simple design. The swivel arm 8 can also be made easier to handle by including an external power drive, especially an electric motor. It is sensible to provide control facilities for the external power drive by means of a control unit which is preferably able to be integrated into the existing x-ray unit controller. This provides the opportunity of combining the tilting of the unit and the operation of overall x-ray device into one controller.

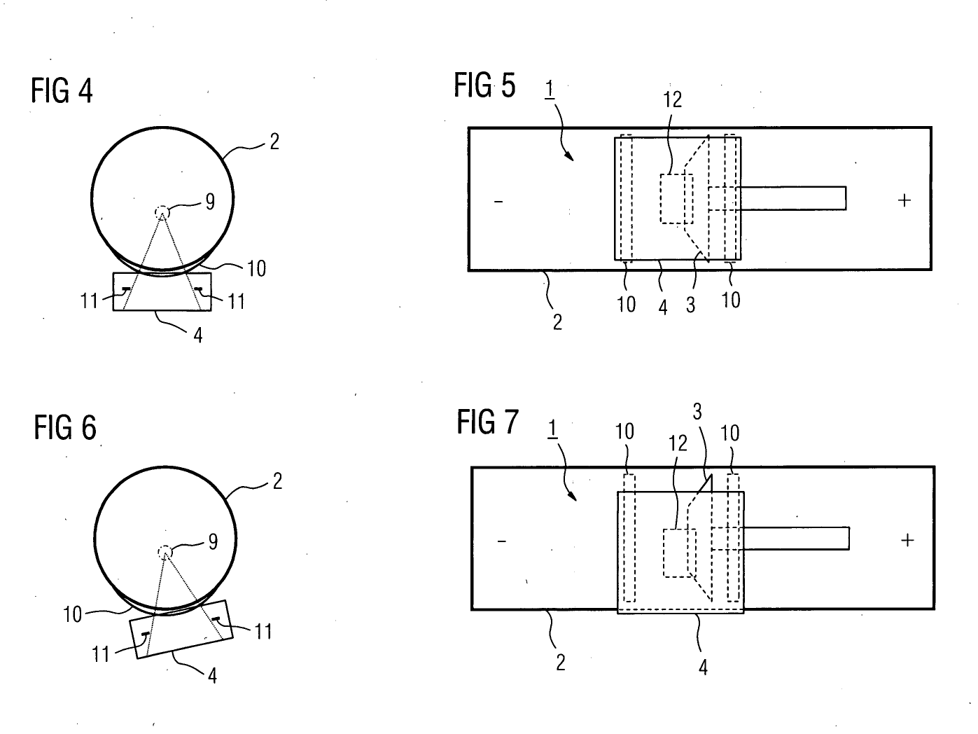

FIG. 4 shows the end-on view on an x-ray housing 2, to which a rail system 10 is attached on which the diaphragm unit can be moved and is thus able to be tilted relative to the x-ray emitter 1. The rail system 10 runs preferably isocentrically to the tube focus 9 of the x-ray emitter 1. In a known way the area of the x-ray exit 12 in accordance with FIG. 5 is defined by the diaphragm blades 11.

If the diaphragm unit 4 is moved in accordance with the invention on the rail system 10 from the position shown in FIG. 4 into a position in accordance with FIG. 6 and thereby tilted relative to the x-ray emitter 1, the x-ray exit 12 changes in accordance with FIG. 7 and makes an asymmetrical display of image areas possible using unchanged diaphragm blades 11. Advantageously the movability is to be made easier by an external drive, especially by an electric motor and a control not shown separately here. In accordance with an embodiment of the invention, the control is able to be integrated into the control of the x-ray device.

The invention can be briefly summarized as follows: the invention relates to a diaphragm unit 4 or a diaphragm unit 4 and an associated x-ray emitter 1 with an adjustment option for displaying an asymmetrical area under investigation, with the diaphragm unit 4 being able to be titled in accordance with the invention relative to the x-ray emitter 1, preferably by movement on a rail system 10 attached isocentrically to the tube focus 9 on the tube housing 2, and/or the unit 1;4 made up of diaphragm unit 4 and x-ray emitter 1 being able to be tilted isocentrically to the tube focus 8 of the x-ray tube 2.

1.-16. (canceled)

17. A diaphragm unit for an x-ray device, comprising an assembly unit accommodating the diaphragm unit, the assembly unit configured to be adjusted in its entirety relative to an x-ray emitter of the x-ray device so that an asymmetrical part of an examination area to be irradiated by the x-ray emitter can be exposed to the x-ray emitter using the diaphragm unit.

18. An x-ray device, comprising:
an x-ray emitter; and
a diaphragm unit facing the x-ray emitter for fading in an examination area, wherein the diaphragm unit or the x-ray emitter include a tilting support so that an asymmetrical part of an examination area to be irradiated by the x-ray emitter can be exposed to the x-ray emitter by tilting the diaphragm unit or the x-ray emitter respectively.

19. The x-ray device according to claim 18, wherein the diaphragm unit is configured to be adjusted relative to the x-ray emitter and independently from the x-ray emitter.

20. The x-ray device according to claim 19, wherein the diaphragm unit and the x-ray emitter form one integrated assembly unit having a tilting support so that an asymmetrical part of an examination area to be irradiated by the x-ray emitter can be exposed to the x-ray emitter by tilting the assembly unit.

21. The x-ray device according to claim 20, wherein the integrated assembly unit is configured to be titled isocentrically relative to an x-ray emitter tube focus of the x-ray emitter.

22. The x-ray device according to claim 21, wherein the assembly unit includes a swivel arm for tilting the assembly unit.

23. The diaphragm unit according to claim 17, further comprising an x-ray emitter tube housing for accommodating the x-ray emitter, wherein the diaphragm unit is constructed and arranged to be moved parallel to the circumference of the x-ray emitter tube housing.

24. The diaphragm according to claim 23, further comprising a guide rail for moving the diaphragm unit.

25. The diaphragm unit according to claim 24, wherein the guide rail is arranged isocentrically relative to an x-ray emitter tube focus of the x-ray emitter.

26. The diaphragm unit according to claim 17, further comprising an electric motor for adjusting the assembly unit by moving the assembly unit.

27 The x-ray device according to 18, further comprising an electric motor for tilting the diaphragm unit or the x-ray emitter.

28. A method of adjusting a diaphragm unit assigned to an x-ray emitter for fading in an examination area to be irradiated by the x-ray emitter, the diaphragm unit accommodated on an assembly unit, the method comprising adjusting a position of the assembly unit relative to the x-ray emitter so that an asymmetrical part of the examination area can be exposed to the x-ray emitter by moving the assembly unit.

29. The method according to claim 25, wherein assembly unit is tilted relative to the x-ray emitter.
